(19) United States
(12) Patent Application Publication
(10) Pub. No.: US 2020/0011821 A1
(43) Pub. Date: Jan. 9, 2020

(54) METHOD FOR MEASURING THE INVADED FOREIGN SUBSTANCE CONTENT INTO A POROUS MATERIAL WITH A FINITE THICKNESS BASED ON PRINCIPLES OF VIRTUAL HEAT SOURCES

(71) Applicant: Dalian University of Technology, Dalian City, Liaoning Province (CN)

(72) Inventors: Tengfei ZHANG, Dalian City, Liaoning Province (CN); Yiheng XU, Dalian City, Liaoning Province (CN); Shugang WANG, Dalian City, Liaoning Province (CN); Jihong WANG, Dalian City, Liaoning Province (CN)

(21) Appl. No.: 16/337,832

(22) PCT Filed: May 28, 2018
(86) PCT No.: PCT/CN2018/088690

§ 371 Date: Mar. 28, 2019

(30) Foreign Application Priority Data
Mar. 28, 2018 (CN) 2018102856202

(51) Int. Cl. G01N 25/20; G01N 25/18

(52) U.S. Cl. CPC G01N 25/20; G01N 25/18

(57) ABSTRACT

This invention addressed a method for measuring the foreign substance content invaded into a thin plate porous material based on the principle of virtual heat sources. The technical points of the invention are: (1) using the principle of virtual heat sources to improve the traditional heat pulse method to measure the foreign substance content; (2) representing the heat transfer effect on boundaries of the thin plate porous material by establishing an infinite number of virtual heat sources with two different heat intensities; (3) obtaining the volumetric heat capacity of the test material together with the invaded foreign substance content based on the four-parameter search to obtain the best temperature match between the measurement and the solution. Unlike the existent methods, there is no specific requirement on the domain size of the test materials and the heat transfer boundary conditions, which makes the measurement of the foreign substance content into the plate-shape test material with a finite thickness more readily.

### FIELD OF THE INVENTION

The invention is with respect to the invaded material detection. A method was proposed for measuring the invaded foreign substance content into a porous material with a finite thickness based on virtual heat source principle.

### BACKGROUND

The absorption or invasion of a foreign substance into a porous material may change the properties of the material itself. For example, once a porous insulation material absorbs water, the thermal insulation and acoustic attenuation performance would be greatly degraded. More critically, microbial growth and various types of corrosion will be resulted, leading to numerous adverse effects. Measurement of the invaded foreign substance content into the porous material would help minimize the negative impacts mentioned above. There are many methods for measuring the invaded foreign substance content, such as water, into porous materials. However, the existent methods still have flaws in terms of pricing, simplicity, and reliability, etc. The heat pulse method infers the absorbed water content based on the dynamic temperature response subject to a sudden heat pulse. The method has been widely studied because of its low cost, simplicity, and ease of implementation.

The article “Probe for measuring soil specific heat using a heat-pulse method” authored by Campbell G S, Calissendorff C, and Williams J H. and published in Soil Science Society of America Journal, 1991, 55 (1): 291-293, proposed a two-probe method for measuring the volumetric heat capacity of soil and the water content therein. The dual probe consisted of a heating needle probe and a temperature sensor probe. The heating needle was in parallel with the temperature sensor probe with a known fixed distance. The heating needle generated a heat pulse of 8 seconds, and the temperature sensor recorded the temperature responses. According to the analytical solution of the maximum temperature rise in an infinitely large medium, the volumetric heat capacity was calculated and then the moisture content was solved. Limited by the adopted assumption, this method can only be used to measure moisture in a material with a sufficiently large size and no heat transfer across the boundary. The paper “An adiabatic boundary condition solution for improving the heat-pulse measurement near the soil-atmosphere interface”, authored by Liu G, Zhao L, Wen M, et al., published in Soil Science Society of America Journal, 2013, 77(2): 422-426, proposed a method for measuring the moisture content in a material with an adiabatic boundary. The method was an improvement to the two-probe heat pulse method. The paper thought that the thermal diffusivity of soil is much larger than that of air, so the soil-air interface could be treated as an adiabatic boundary, as evaluated by their conducted COMSOL simulation. A virtual heat source with the same flux as the actual source, i.e., qᵥᵢᵣₜᵤₐₗ=qᵣₑₐₗ, was added to the image of the actual heat source with respect to the assumed adiabatic boundary. Hence, the temperature response in a semi-infinite domain bounded by an adiabatic boundary can be approximated into the temperature response by two symmetric identical heat sources in an infinite domain. The temperature rises calculated by the above model were matched with the measured temperature rises to obtain the material's volumetric capacity and water content. However, the material-air interface may not be the exact adiabatic boundary especially when the heat probe was very close to the interface, which limits wide application of this method.

The Chinese invention patent application, No. CN107356627A, proposed a method for determining the invaded foreign substance content into a porous material based on principle of virtual heat source and using four-parameter matching. A virtual heat source in the image of the actual heat source with respect to the heat loss boundary was added into the domain. The ratio of the virtual heat source's intensity qᵥᵢᵣₜᵤₐₗ to the actual heat source's intensity qᵣₑₐₗ was defined as n. Before proposing this method, n was assigned a fixed value of either −1 or 1. Consequently, the thermal boundary of either constant temperature (n=−1) or no heat flow (adiabatic, n=1) was reproduced. This invention extended n into an arbitrary value between −1 and 1. When n is assigned a value other than −1 and 1, it represents a certain thermal boundary with a finite heat transfer rate. In a solution, the virtual heat source's intensity (n), the material's thermal properties, and the mass content of the invaded substance were determined by matching the measured temperatures. Because the above method accounted for heat transfer across the boundary, the accuracy of measuring moisture content in a semi-infinite material with or without heat transfer can be much improved. The required test material's volume using this method is only half of that using the conventional heat pulse method. The heat transfer across the boundary can be arbitrary.

The above review reveals that there are many researches on development of the heat pulse method. The existing methods require that the measured material has a sufficiently large size or a semi-infinite size containing a single boundary for heat transfer. However, in practical use, most of the test materials have only a finite size in a thin plate shape, such as the thermal insulation materials to minimize the building's heat transfer. When adopting the heat pulse method for measurement, the heat transfer across boundaries is unknown and cannot be ignored. The existing methods cannot measure the foreign substance content into the plate-shape material with a finite thickness.

This invention proposed to employ an infinite number of virtual heat sources with two different heat intensities. The ratios of these two different heat intensities to the actual heat source's intensity qᵣₑₐₗ were defined as n₁ and n₂, respectively. n₁ and n₂ could be an arbitrary number between −1 and 1. Through superposition of temperatures by the actual and virtual heat sources in an infinite space, the temperature responses due to the heating of the probe inside the plate-shape material can be quickly solved. Then the volumetric heat capacity and the foreign substance content can be inferred provided with the measured temperatures.

### SUMMARY OF THE INVENTION

The aim of this invention is to provide a method for measuring the foreign substance content into a thin plate porous material based on the principle of virtual heat sources.

The technical schemes of the invention are as follows:

The operating steps of a method for measuring the foreign substance content into a porous material with a finite thickness based on the principle of virtual heat sources:

(1) Place the plate-shape test material in a sunshade environment. Avoid strong radiation heat transfer between the surrounding environment and the surfaces of the test material. Deploy a needle like heating element inside the test material and assure the heating element is in parallel with the outer boundaries. Deploy the temperature sensors at two or more locations within the test material. The distances of each temperature sensor away from the heating element should be known and different.

(2) Before turning on the heating element, make sure the initial temperature of the test material is uniformly distributed and stable, and record the temperature as the initial temperature. Turn on the heating element according to the specified known constant intensity (heating power rate per unit length), and collect the temperature responses using the sensors. The differences of the recorded transient temperatures with the initial temperature are the temperature rises at the sensor positions.

(3) Establish an infinite number of virtual heat sources according to the principle of virtual heat sources, and obtain an approximate solution of the temperature rises at the sensor locations.

Following the Chinese Patent Application, No. CN107356627A, a virtual heat source was added to represent a specific heat transfer boundary in a semi-infinite domain. One of the heating elements in the domain is the actual one with a heating intensity of qᵣₑₐₗ. The other heating element is the virtual one located at the image of the actual heating element with respect to the heat transfer boundary. The virtual heating element has an intensity of qᵥᵢᵣₜᵤₐₗ=n·qᵣₑₐₗ, where n is an arbitrary rational number between −1 and 1. If n=1, the boundary is adiabatic; if n=−1, the boundary has constant temperature; if −1<n<1, the boundary is between adiabatic and constant temperature.

In this invention, the test material has two parallel boundaries with a finite separating distance. As shown in FIG. 2, following the Chinese patent application CN107356627A, virtual heat sources q₁ and q₂ are established at the images of the actual heat source qᵣₑₐₗ with respect to boundaries A and B, respectively. Because the numbers of heat sources (real and virtual sources counted together) on both sides of boundary A or B are not equal, an additional virtual heat source q₂′ is established at the image of q₂ with respect to boundary A and an additional virtual heat source q₁′ at the image of q₁ with respect to boundary B. This is to eliminate the impacts to boundaries B and A due to adding q₁ and q₂ to the domain, respectively. The image process is repeated to establish an infinite number of virtual heat sources. The temperatures of the test material are obtained by adding the temperatures of the actual heat source and an infinite number of virtual heat sources in an infinite domain.

The actual source's heat intensity is qᵣₑₐₗ, which is known and controlled in the measurement process. The intensities of the virtual heat sources are divided into two categories, according to the above naming rule, the virtual heat sources with the subscript 1 have the same heating intensity of n₁·qᵣₑₐₗ; the virtual heat sources with the subscript 2 share the same heating intensity of n₂·qᵣₑₐₗ. n₁ and n₂ are arbitrary rational numbers ranging from −1 to 1. If n₁ or n₂ is equal to −1 or 1, it designates the outer boundary A or the outer boundary B as the constant temperature or adiabatic type, respectively.

In the actual measurement process, in most cases, the boundaries A and B are between the constant temperature and the adiabatic types, so n₁ and n₂ range from −1 to 1. Because the heat transfer conditions on boundaries A and B are unknown, the estimation of the heat transfer rates on boundaries A and B is converted into a solution for n₁ and n₂. It should be aware that the above description is based on the assumption that the impacts of the heating element itself to heat transfer are negligible. That is, the heating element can be simplified into an infinite long-line heat source.

As shown in FIG. 2, the symbols of S1 and S2 are the temperature sensor deploying positions in step (1) (Note that S1 and S2 in FIG. 2 are only one special case of placing temperature sensors). The temperature rises at S1 and S2 are obtained by adding the temperature rise contributed by the actual source qᵣₑₐₗ and an infinite number of virtual heat sources (q₁, q₂, q₁′, q₂′, . . . ).

(4) Compare the recorded temperature rises at the sensor locations in step (2) with the approximate solution temperature rises at the corresponding positions in step (3). The root mean square error or other errors, such as DEV, can be adopted to evaluate the time-dependent temperature rise differences between the measurement and the solution. Then the following four parameters are searched: the thermal conductivity k of the test material, the volumetric heat capacity ρc, the parameter n1 representing the heat transfer on boundary A, and the parameter n2 representing the heat transfer on boundary B. The values or range of values of the four parameters should make the DEV minimum or within the set acceptable level.

(5) The content or content range of the foreign substance into the porous material is calculated based on the corresponding change of the volumetric heat capacity □c after the invasion of the foreign substance with a certain mass.

Beneficial effects of this invention: The present invention provides a method for measuring the invaded mass of the foreign substance into a finite-thickness flat plate material. An infinite number of virtual heat sources were proposed to approximate the certain heat transfer on boundaries of the plate material. Unlike the existent methods, there is no specific requirement on the domain size of the test materials and the heat transfer boundary conditions, which makes the measurement more readily.

### DESCRIPTION OF DRAWINGS

FIG. 1 is an example of deploying a detection probe for measuring the foreign substance content into a finite-thickness flat plate porous material. The measuring probe contains a handle and three stainless steel needles. In the figure, symbol 1 designates the handle, 2 is the heating element, 3 is the two temperature sensors S1 and S2 on both sides of the heating element. Symbols R_{S1} and R_{S2} are the distances of the heating element from the two temperature sensors. A finite rate heat transfer occurs on boundaries A and B. Symbols D₁ and D₂ are the distances of the measurement probe away from boundaries A and B, respectively.

FIG. 2 is a schematic diagram for adopting the proposed method of virtual heat sources to derive the approximate solution of temperature rises. The actual heat source is located in the position of the heating needle, and its heating intensity is qᵣₑₐₗ. A virtual heat source q₁ is located at the image of qᵣₑₐₗ with respect to boundary A, whose heating intensity is n₁·qᵣₑₐₗ. The virtual heat source q₂ is located at the image of qᵣₑₐₗ with respect to boundary B with a heating intensity of n₂·qᵣₑₐₗ. The virtual heat source q₁′ is located at the image of q₁ with respect to boundary B and its heating intensity is n₁·qᵣₑₐₗ. The virtual heat source q₂′ is located at the image of q₂ with respect to boundary A and its heating intensity is n₂·qᵣₑₐₗ. S1 and S2 are two temperature sensors. D₁ and D₂ are the distances of the measurement probe position from boundaries A and B, respectively. Boundaries A and B are parallel.

FIG. 3 is a flow chart to measure the foreign substance content. In the figure, ΔT_{E} is the measured temperature rise (° C.) by a sensor. ΔT_{M} is the approximate solution temperature rise (° C.) at the sensor location based on the proposed invention. f is the approximate solution of the transient temperature rise as a function of ρc, k, n₁ and n₂, in which ρc is the volumetric heat capacity of the test material (Jm⁻³K⁻¹), k is the thermal conductivity of the test material (Wm⁻¹ K⁻¹), and n₁ and n₂ are the ratios of the virtual heat source's intensity to the actual heat source's intensity ranging from −1 to 1. DEV is the temperature rise differences between ΔT_{M} and ΔT_{E}. g is a function to calculate DEV. X is a four-dimensional variable or ensemble. Min is a function in the Matlab software to search for the minimum value of the function in a certain parametric range.

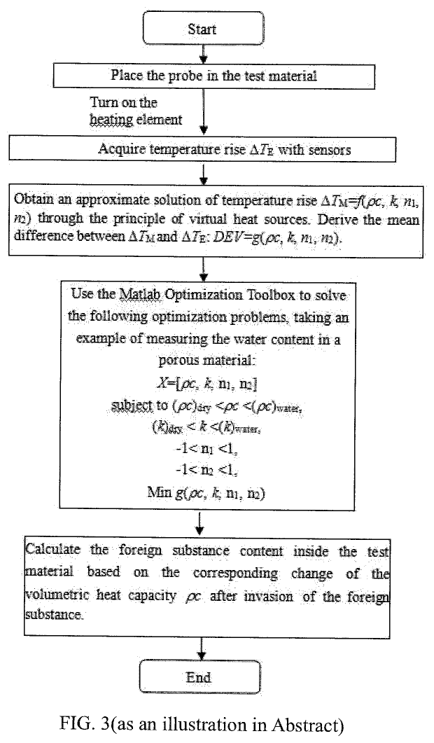

### IMPLEMENTATION STEPS

The implementation of the invention will be further described by taking a finite-thickness flat plate porous material to measure the invaded foreign substance content, such as the water content therein, as an example.

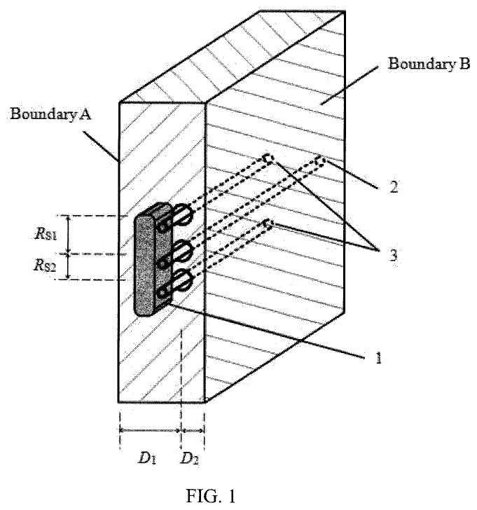

The operating steps for measuring the foreign substance content into a porous material with a finite thickness based on the principle of virtual heat sources are as follows:
(1) Place the plate-shape test material in an environment without intensive radiation heat transfer. Deploy a needle-shape heating element inside the test material and assure the heating element is in parallel with the outer boundaries. If thermal properties of the heating element can be neglected in calculation, the heating element can be treated as an infinite long-line heat source. Because the heating element shall be rigid enough, it is recommended to use a stainless steel hollow needle with an outer diameter of 1.6 mm to embed with the resistance wire inside. As shown in FIG. 1, D₁ is the distance between the heating element and boundary surface A, and D₂ is the distance between the heating element and boundary surface B. Two temperature sensors are recommended for use, in which the distances between the two temperature sensors and the heating element are R_{S1} and R_{S2}, respectively. The separating distance of the two temperature sensors from boundary A is D₁ and from boundary B is D₂. For operation convenience, a measuring probe as shown in FIG. 1 can be built.
(2) Wait until the temperatures in the wet porous material are uniformly distributed and stable, and then record the initial temperature T_{E,0}. Provide a sudden constant heat flow to the heating element. Collect and record the temperature T_{E,i} at each time interval. The measured temperature rise ΔT_{E,i} is obtained by subtracting the initial temperature T_{E,0} from T_{E,i}. Subscript i is the index of the measurement interval. Our suggestion is to sample every 5s for a total duration of 100 s.
(3) Calculate the approximate solution of the transient temperatures at the sensor locations.

Temperature rise due to a linear heat source in an infinite space can be formulated as:

$$Δ {T}_{M , th} ( q , r ) = \frac{q}{4 π k} \times {\int }_{\frac{ρ {cr}^{2}}{4 k τ}}^{∞} \frac{{e}^{- u}}{u} du \qquad ( 1 )$$

where ΔT_{M,th}(q, r) is the temperature rise (° C.) at a distance r (m) from a heat source with the heating intensity q (Wm⁻¹), k is the thermal conductivity of the test material (Wm⁻¹ K⁻¹), ρ is the test material's density (kgm⁻³), c is the specific heat capacity of the test material (Jkg⁻¹ K⁻¹), ρc is the volumetric heat capacity of the test material (Jm⁻³ K⁻¹), τ is time (s).

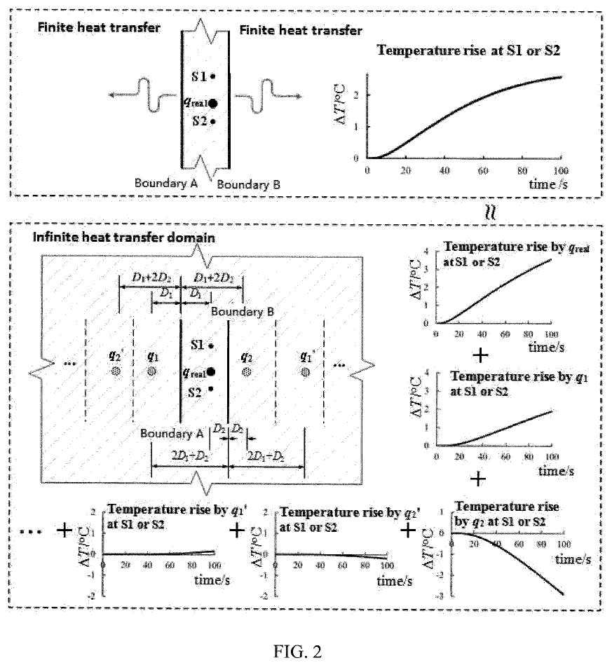

According to the principle of virtual heat sources, as shown in FIG. 2, the approximate solution of the temperatures at the sensor locations can be obtained by adding the temperature rises by the actual source qᵣₑₐₗ and an infinite number of virtual heat sources (q₁, q₂, q₁′, q₂′, . . . ). In practical operation, the required number of virtual heat sources can be determined based on the saturation judgement. That is, if the contribution of one more virtual heat source to the temperature rises at sensor location was less than 1% of the total temperature rise, the number of virtual heat sources has reached a relative saturation and no more virtual heat source is required. The following outlines an approximate solution after two image process with a total of four virtual heat sources. The approximate solution is:

ΔT_{M}=ΔT_{M,th}(qᵣₑₐₗ,rᵣₑₐₗ)+ΔT_{M,th}(q₁,r₁)+ΔT_{M,th}(q₂,r₂)+ΔT_{M,th}(q₁′,r₁′)+ΔT_{M,th}(q₂′,r₂′) (2)

where ΔT_{M} is the temperature rise (° C.) by the actual and a sufficient number of virtual heat sources; ΔT_{M,th}(q, r) is the temperature rise (° C.) at a distance r from the heat source whose intensity is q; qᵣₑₐₗ is the heat source intensity of the actual heating element (Wm⁻¹), which is known and controlled in the measurement process; rᵣₑₐₗ(m) is the distance between the temperature sensor and the actual heat source. rᵣₑₐₗ is R_{S1} or R_{S1}. q₁, q₂, q₁′ and q₂′ are the heating intensities of the four virtual heat sources with a distance from the temperature sensor of r₁, r₂, r₁′ and r₂′ (m), respectively.

The relationship of q₁, q₂, q₁′ and q₂′ qᵣₑₐₗ is:

q₁=q₁′=n₁·qᵣₑₐₗ (3)

q₂=q₂′=n₂·qᵣₑₐₗ (4)

where n₁ and n₂ are the rational number representing the heat transfer rate on boundaries A and B, and n₁ and n₂ range from −1 to 1.

The distances of r₁, r₂, r₁′ and r₂′ are related to the position of the temperature sensor, and is a function of rᵣₑₐₗ, D₁ and D₂. According to FIG. 2, r₁, r₂, r₁′ and r₂′ can be calculated as:

r₁=\sqrt{rᵣₑₐₗ²+(2D₁)²} (5)

r₂=\sqrt{rᵣₑₐₗ²+(2D₂)²} (6)

r₁′=\sqrt{rᵣₑₐₗ²+(2D₁+2D₂)²} (7)

r₂′=\sqrt{rᵣₑₐₗ²+(2D₁+2D₂)²} (8)
where D₁ is the separating distance (m) of the actual heat source from boundary A; D₂ is the distance (m) of the actual heat source from boundary B.
(4) DEV is the average temperature rise difference between the measurement and the solution. The root mean square error format of DEV is:

$$DEV = \sqrt{{\sum }_{i = 1}^{i = m} {( Δ {T}_{M , i} - Δ {T}_{E , i} )}^{2} \text{/} m} \qquad ( 9 )$$

where ΔT_{M,i} is the temperature rise (° C.) for the ith time interval index; ΔT_{E,i} is the measured temperature rise (° C.) at the ith time interval index; and in is the total number of sampled temperature data points in the measurement. If using two temperature sensors, two sets of temperature rise data and DEV can be obtained, and the final DEV can be the average of the two DEVs.
(5) Four parameters are searched for the best match between the measured and the solved temperature rises: the thermal conductivity k of the test material, the volumetric heat capacity ρc, the parameter n₁ representing the heat transfer on boundary A, and the parameter n₂ representing the heat transfer on boundary B. The values of the four parameters should make the DEV minimum. In practical operation, if DEV≤DEV_{accept}, the search operation for the minimum DEV can also be terminated.

The range of the four parameters for searching can be set into: the thermal conductivity k ranging from that of the pure test material without any invaded substance to that of the pure invaded substance, and so do for the volumetric heat capacity ρc; n₁ and n₂ ranging from −1 to 1. It is recommended to use the Matlab optimization toolbox to search for the above expected four parameters.
(6) The content or content range of the invaded substance into the porous material is calculated based on the change in volumetric heat capacity ρc after invasion of the foreign substance as:

$${x}_{w} = \frac{ρ c - {ρ}_{0} {c}_{0}}{{c}_{w}} \qquad ( 10 )$$

where x_{w} is the volumetric mass of the invaded foreign substance (for water, the unit is kg H₂Om⁻³); ρc is the volumetric heat capacity (Jm⁻³ K⁻¹) of the test material with the invaded foreign substance; ρ₀ is the density of the test material before invasion of the foreign substance (kgm⁻³); c₀ is the specific heat capacity of the test material before invasion of the foreign substance (Jkg⁻¹ K⁻¹); and c_{w} is the specific heat capacity of the pure invaded foreign substance (Jkg⁻¹ K⁻¹). The volumetric heat capacity of the test material before invasion of the foreign substance ρ₀c₀ can be obtained from the handbook, or measured by the proposed method in this invention.

1. A method for measuring the invaded foreign substance content into a porous material with a finite thickness based on principles of virtual heat sources, wherein the technical schemes of the invention are as follows:
(1) place the plate-shape tested material in a sunshade environment; avoid strong radiation heat transfer between the surrounding environment and the surfaces of the tested material; deploy a needle like heating element inside the tested material and assure the heating element is in parallel with the outer boundary; deploy the temperature sensors at two or more locations within the tested material; the distances of each temperature sensor away from the heating element should be known and different;
(2) before turning on the heating element, make sure the initial temperature of the test material is uniformly distributed and stable, and record the temperature as the initial temperature; turn on the heating element according to the specified known intensity and collect the temperature responses using the sensors; the differences of the recorded transient temperatures with the initial temperature are the temperature rises at the sensor positions;
(3) establish an infinite number of virtual heat sources according to the principle of virtual heat sources, and obtain an approximate solution of the temperature rises at the sensor locations;
Following the Chinese patent application CN107356627A, two virtual heat sources q₁ and q₂ are established at the images of the actual heat source qᵣₑₐₗ with respect to boundaries A and B, respectively; boundaries A and B are parallel; because the numbers of heat sources (actual and virtual sources counted together) on both sides of boundary A or B are not equal, an additional virtual heat source q₂′ is established at the image of q₂ with respect to boundary A and an additional virtual heat source q₁′ at the image of q₁ with respect to boundary B; the image process is repeated to establish an infinite number of virtual heat sources; the temperatures inside the test material are obtained by adding the temperatures generated by the actual heat source and an infinite number of virtual heat sources in the infinite heat transfer domain;
The actual source's heat intensity is qᵣₑₐₗ, which is known and controlled in the measurement process; the intensities of the virtual heat sources are divided into two categories, according to the above naming rule, the virtual heat sources with the subscript 1 have the same heating intensity of n₁·qᵣₑₐₗ; the virtual heat sources with the subscript 2 share the same heating intensity of n₂·qᵣₑₐₗ. n₁ and n₂ are arbitrary rational numbers ranging from −1 to 1; if n₁ or n₂ is equal to −1 or 1, it designates boundary A or B as the constant temperature or adiabatic type, respectively; in the actual measurement process, in most cases, boundaries A and B are between the constant temperature and the adiabatic types, so n₁ and n₂ range from −1 to 1; because the heat transfer conditions on boundaries A and B are unknown, n₁ and n₂ are unknown too;
(4) compare the recorded temperature rises at the sensor locations in step (2) with the approximate solution temperature rises at the sensor locations in step (3); DEV is the average temperature rise difference between the measurement and the solution; then the following four parameters are searched for the best match between the measured and the solved temperature rises: the thermal conductivity k of the test material, the volumetric heat capacity ρc, the parameter n₁ representing the heat transfer boundary A, and the parameter n₂ representing the heat transfer boundary B; the values or range of values of the four parameters should make the DEV minimum or within the set acceptable level;
(5) the content or content range of the foreign substance invaded into the porous material is calculated based on the corresponding change of the volumetric heat capacity ρc after invasion of the foreign substance with a certain mass.
